(19) United States
(12) Patent Application Publication
(10) Pub. No.: US 2011/0211557 A1
(43) Pub. Date: Sep. 1, 2011

(54) HANDOVER PROCESSING METHOD, AND MOBILE NODE, CONNECTION MANAGING APPARATUS AND BASE STATION USED IN THAT METHOD

(75) Inventors: Hong Cheng, Singapore (SG); Tien Ming Benjamin Koh, Singapore (SG); Pek Yew Tan, Singapore (SG); Takako Hori, Kanagawa (JP); Shinkichi Ikeda, Kanagawa (JP); Jun Hirano, Kanagawa (JP); Takashi Aramaki, Osaka (JP)

(73) Assignee: PANASONIC CORPORATION, Osaka (JP)

(21) Appl. No.: 13/061,676

(22) PCT Filed: Sep. 1, 2009
(86) PCT No.: PCT/JP2009/004297

§ 371 Date: May 17, 2011

(30) Foreign Application Priority Data
Sep. 4, 2008 (JP) 2008-227151

(51) Int. Cl. H04W 36/14

(52) U.S. Cl. 370/331

(57) ABSTRACT

Disclosed is a technique which provides a handover processing method and the like which enable a smooth handover without service interruption and allow a desired handover to be performed. The technique includes the steps of: generating by a mobile node 100 a message including certain information to prioritize a connection of the mobile node to a desired access network among multiple access networks; transmitting the generated message from the mobile node to a base station located in the desired access network or a base station located in a currently-connected access network; and rejecting by a connection managing apparatus 104 for managing connections of the mobile node a path switching request from a base station of an access network other than the desired access network, the rejection being made according to certain information acquired through a base station that receives the transmitted message.

### TECHNICAL FIELD

The present invention relates to a mobile node handover processing method for a mobile node applied to a case where there are multiple entities which control handovers of the mobile node, and where the control entities perform the handovers of the mobile node around the same time. The invention also relates to a mobile node, a connection managing apparatus and a base station used in the method.

### BACKGROUND ART

Most large-scale networks are networks managed by certain mobility schemes. A proxy mobile Internet protocol (PMIP, see Non-Patent Document 1) network may be cited as an example. In such an environment, the configuration of a mobile node can be made simple, and a user (operator) can have better control over the service. In these networks, handovers of mobile nodes are usually determined and initiated by the network.

However, this type of configuration does not function correctly for a mobile node equipped with multiple access techniques. For example, there may be a case where even though a 3G connection functions correctly, a mobile node may determine to perform a handover to IEEE802.11WLAN (wireless local area network) or WIMAX (world interoperability for microwave access) access because of cost and other reasons.

Such a mobile node is permitted to start a handover, by indicating to the network of an intention to perform a handover. For example, on the basis of a handover determination algorithm output, the mobile node can perform signaling to the network to disconnect from the 3G network and can perform a handover to a different-type network.

### PRIOR ART DOCUMENT

### Non-Patent Document

Non-Patent Document 1: S. Gundavelli et al, “Proxy Mobile IPv6”, RFC5213, August 2008, http://www.ietf.org/rfc/rfc5213.txt
Non-Patent Document 2: “3GPP TS 23.401 V8.1.0”, ftp://ftp.3gpp.org/specs/2008-03/Rel-8/23_series/
Non-Patent Document 3: “3GPP TS 23.402 V8.1.1”, ftp://ftp.3gpp.org/specs/2008-03/Rel-8/23_series/
Non-Patent Document 4: B. Ababa et al, “Extensible Authentication Protocol”, RFC3748, June 2004, http://www.ietf.org/rfc/rfc3748.txt
Non-Patent Document 5: B. Aboba et al, “The Network Access Identifier”, RFC4282, December 2005, http://www.ietf.org/rfc/rfc4282.txt

However, there is a problem in this handover. Usually, a long time is required for the mobile node to perform a handover to a different-type network. This causes a service interruption. Due to the difference in the access techniques, the connection context of the old access cannot be applied to the new access directly. For this reason, it requires some time to establish the new access and to re-establish the connection. However, connection to the old access is disconnected before the new access is established, and thus the service is interrupted.

Further, when a network-initiated handover and a mobile node-initiated handover are performed simultaneously, signaling conflicts occur and may cause an undesired handover. In the worst case, the mobile node loses all its connections. In view of these problems, a better method is desired to appropriately control the operation of the mobile node in a data communication network.

### SUMMARY OF THE INVENTION

The present invention has been made in view of the above problems, and aims to provide a handover processing method which enables a smooth handover without service interruption and allows a desired handover to be performed. The invention also aims to provide a mobile node, a connection managing apparatus and a base station that can be used in the method.

In order to achieve the above aim, according to the present invention, there is provided a handover processing method for a mobile node applied to a case where, in a communication system in which a mobile node is configured to communicate with a correspondent node via a communication network formed of a plurality of access networks and which includes a connection managing apparatus managing connections of the mobile node, a plurality of entities for controlling handovers of the mobile node exist, including the mobile node itself, and some of the plurality of entities may perform handover processing of the mobile node, the method comprising the steps of: generating by the mobile node a message including certain information for prioritizing a connection of the mobile node to a desired access network among the plurality of access networks; transmitting the generated message from the mobile node to any of a base station located in the desired access network or a base station located in a currently-connected access network; and rejecting by the connection managing apparatus a path switching request issued for a handover of the mobile node by a base station in an access network other than the desired access network, the rejection being made in accordance with the certain information acquired through the base station which receives the transmitted message. This configuration enables smooth handover without service interruption, and allows a desired handover to be performed. Note that the connection managing apparatus corresponds to a later-described SG.

In addition, according to the present invention, there is provided a mobile node used in a handover processing method for a mobile node applied to a case where, in a communication system in which the mobile node is configured to communicate with a correspondent node via a communication network formed of a plurality of access networks and which includes a connection managing apparatus managing connections of the mobile node, a plurality of entities for controlling handovers of the mobile node exist, including the mobile node itself, and some of the plurality of entities may perform handover processing of the mobile node, the mobile node comprising: message generation unit for generating a message including certain information for prioritizing a connection of the mobile node to a desired access network among the plurality of access networks; and transmission unit for transmitting the generated message to any of a base station located in the desired access network or a base station located in a currently-connected access network. This configuration enables smooth handover without service interruption, and allows a desired handover to be performed.

Moreover, according to the present invention, there is provided a connection managing apparatus used in a handover processing method for a mobile node applied to a case where, in a communication system in which the mobile node is configured to communicate with a correspondent node via a communication network formed of a plurality of access networks and which includes a connection managing apparatus managing connections of the mobile node, a plurality of entities for controlling handovers of the mobile node exist, including the mobile node itself, and some of the plurality of entities may perform handover processing of the mobile node, the connection managing apparatus comprising: reception unit for receiving a path switching request message from a base station located in an access network other than an access network that the mobile node desires among the plurality of access networks; determination unit for determining whether or not to reject a path switching request issued for a handover of the mobile node which is a request from the base station located in the access network other than the desired access network, the determination being made in accordance with certain information included in a message generated by the mobile node and prioritizing a connection of the mobile node to the desired access network among the plurality of access networks; and transmission unit for, in a case where the path switching request is determined to be rejected, transmitting a message indicating the rejection of the path switching request to the base station located in the access network other than the desired access network. This configuration enables smooth handover without service interruption, and allows a desired handover to be performed.

Furthermore, according to the present invention, there is provided a base station used in a handover processing method for a mobile node applied to a case where, in a communication system in which the mobile node is configured to communicate with a correspondent node via a communication network formed of a plurality of access networks and which includes a connection managing apparatus managing connections of the mobile node, a plurality of entities for controlling handovers of the mobile node exist, including the mobile node itself, and some of the plurality of entities may perform handover processing of the mobile node, the base station comprising: reception unit for receiving a message which is generated by the mobile node and which includes certain information for prioritizing a connection of the mobile node to a desired access network among the plurality of access networks; message generation unit for acquiring the certain information included in the received message and either generating a message including the acquired certain information or generating a path switching request message including the acquired certain information; and transmission unit for transmitting any of the generated message and the generated path switching request message to any of a certain apparatus or the connection managing apparatus. This configuration enables smooth handover without service interruption, and allows a desired handover to be performed.

The handover processing method, the mobile node, the connection managing apparatus and the base station used in the method of the present invention enable a smooth handover without service interruption, and allow a desired handover to be performed.

### BRIEF DESCRIPTION OF THE DRAWINGS

FIG. 1 is a configuration diagram showing an example of a network configuration in first and second embodiments of the present invention.

FIG. 2 is a sequence chart showing an example of a signaling sequence for describing a condition of solving means in the first embodiment of the present invention.

FIG. 3 is a configuration diagram showing a part of a network configuration in the first embodiment of the present invention.

FIG. 4 is a sequence chart showing an example of a processing sequence in the first embodiment of the present invention.

FIG. 5 is a configuration diagram showing an exemplar configuration of an MN according to first to third embodiments of the present invention.

FIG. 6 is a message format showing an example of a PSV object in the first to third embodiments of the present invention.

FIG. 7 is a configuration diagram showing an exemplar configuration of an SG according to the first to third embodiments of the present invention.

FIG. 8 is a sequence chart showing an example of a processing sequence in the second embodiment of the present invention.

FIG. 9 is a configuration diagram showing an exemplar configuration of an is AD (base station) according to the second embodiment of the present invention.

FIG. 10 is a message format showing an example of a PBU message according to the first to third embodiments of the present invention.

FIG. 11 is a message format showing an example of an extended EAP message according to the first embodiment of the present invention.

FIG. 12 is a message format showing an example of an extended AAA_Authorize_Ans message according to the first embodiment of the present invention.

FIG. 13 is a sequence chart showing an example of a processing sequence in the third embodiment of the present invention.

FIG. 14 is a sequence chart showing an example of another processing sequence in the third embodiment of the present invention.

FIG. 15 is a sequence chart showing an example of another processing sequence in the third embodiment of the present invention.

### DESCRIPTION OF EMBODIMENTS

### First Embodiment

In the following description of first to third embodiments, numerical values, time, configurations, protocols and parameters are given for understanding of the invention, and do not limit the invention.

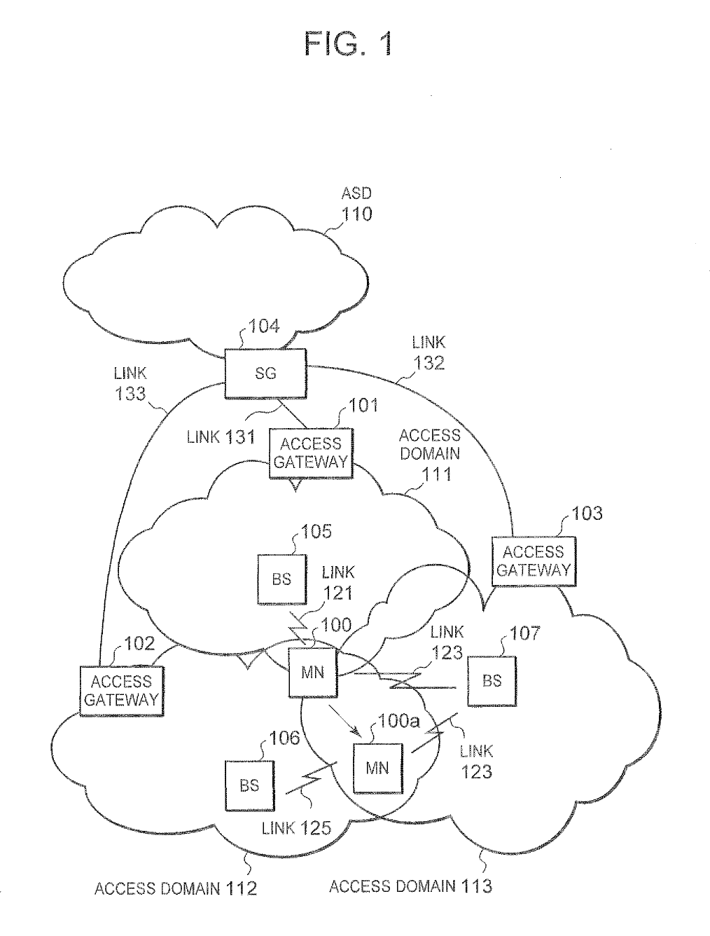

FIG. 1 shows an example of a network configuration in the first embodiment of the present invention. As shown in FIG. 1, a mobile node MN 100 having multiple access technologies receives a service from an ASD (application service domain) 110 via an AD (access domain) 111. The MN 100 connects to the AD 111 via a BS (base station) 105 through a link 121 by using one (referred to here as an interface 1) of its access interfaces. The AD 111 provides access to the ASD 110 via an SG (service gateway) 104 through a link 131 and an AG (access gateway) 101.

At one point, the MN 100 detects another access domain AD 113. According to certain information and criteria such as a charge rate and a QoS (quality of service) level, the MN 100 determines to perform a handover to the AD 113 and accesses the service through an AG 103. It is obvious to those skilled in the art that the MN 100 has various methods to acquire information and to determine the handover. For example, the MN 100 may use IEEE802.21 which is based on a mechanism of acquiring information through the AD 111 or directly through the AD 113.

The MN 100 starts to set up a connection with the AD 113. The MN 100 uses an interface (referred to here as an interface 2) to connect to the AD 113 via a BS 107 through a link 123. The AD 113 provides access to the ASD 110 via the SG 104 through the AG 103 and a link 132.

During the setup procedure for connection with the AD 113, the MN 100 moves to a new position 100a which is out of AD 111 coverage and within AD 112 coverage. Here, the position 100a may be a position within AD 111 coverage but preferable for connection with the AD 112. In other words, the position may have a better connection environment (such as a radio environment) for the AD 112 than for the AD 111.

The AD 112 is a network that supports a network-initiated handover from the AD 111. An example of such a network is two sub domains of a 3G network. Similar to the AD 111, the AD 112 provides access to the ASD 110 via an AG 102 through a link 133. Hence, the network starts handover processing and instructs the MN 100 to connect to a BS 106 of the AD 112 through a link 125 by using the interface 1. A handover procedure on the network side, such as switching of data paths, is performed.

Networks based on a mobility management scheme are used in the links 131, 132 and 133, and PMIP (refer to Non-Patent Document 1) or GTP (general packet radio services tunneling protocol) is used, for example.

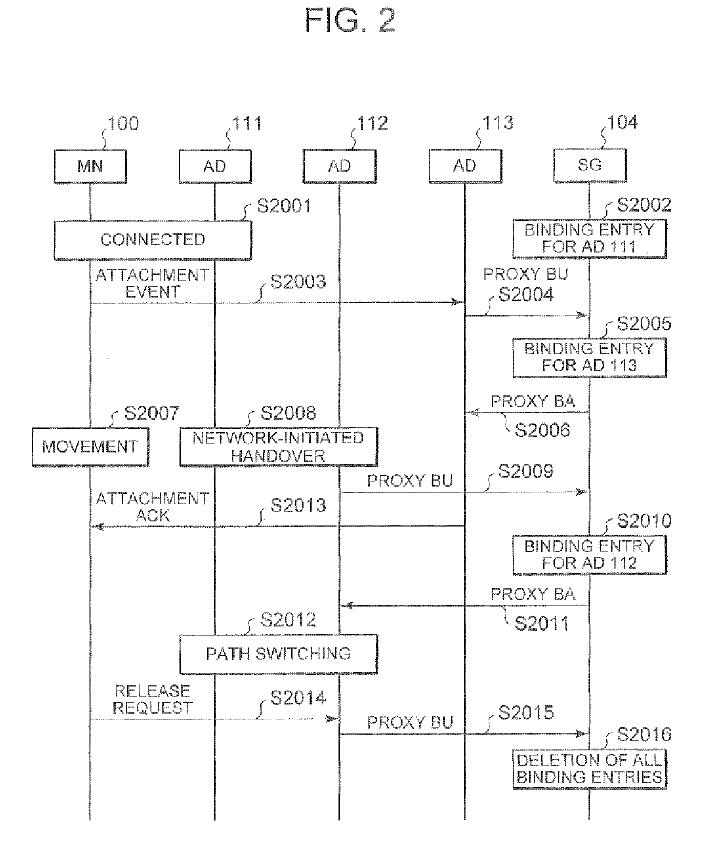

FIG. 2 shows a signaling sequence for describing a problem of the system. Here, PMIPv6 is used as an exemplar scheme for the links 131, 132 and 133. To avoid complication, FIG. 2 shows signaling control only in an abstract manner, and each access domain is simply shown as a single entity. It is obvious to those skilled in the art that actual signaling requires a larger number of entities performing a larger number of message exchanges.

As shown in FIG. 2, the MN 100 is connected to the AD 111 in the beginning (step S2001). At this point, the SG 104 has position registration information (binding entry) for the AD 111 (step S2002). Based on this binding entry, the SG 104 knows how to transfer data to the MN 100. Note that a binding entry is a binding cache entry described in Non-Patent Document 1, for example.

At one point, the MN 100 determines to connect to the AD 113 and starts an attachment event (step S2003). It is obvious to those skilled in the art that this step includes multiple steps such as establishment of L2 (layer 2) connection, authentication processing and the like.

After detecting the attachment event of the MN 100, a MAG (mobile access gateway) in the AD 113 such as the AG 103 updates the binding entry of an LMA entity (local mobility anchor) such as the SG 104 by use of a proxy BU (PBU: proxy binding update) message (step S2004). A format of the PBU message and examples of the MAG and LMA are defined in Non-Patent Document 1.

If this PBU message is accepted by the SG 104 after consulting the AAA (authentication authorization and accounting) server, the binding entry of the MN 100 in the SG 104 is changed. After the change, a binding entry for the AD 113 is held in the SG 104 (step S2005). The SG 104 responds to the PBU with a proxy BA (PBA: proxy binding acknowledge) message (step S2006). After receiving the PBA, the AD 113 is aware that a connection is set up by the network.

At the same time, when the MN 100 moves to a new position 100a (step S2007), the AD 111 and the AD 112 start a network-initiated handover (step S2008). It is obvious to those skilled in the art that this step includes multiple steps not mentioned in detail, such as data forwarding, exchange of path switch messages between networks and the like.

After the network-initiated handover processing, a MAG in the AD 112 such as the AG 102 transmits a PBU to the LMA entity such as the SG 104 to update a data path (step S2009). After similar processing of the PBU by the SG 104, the binding entry is changed to that for the AD 112 (step S2010). The SG 104 notifies the change by a PBA (step S2011), and network handover processing such as data path switching is performed between the AD 111 and the AD 112 (step S2012).

In the meantime, the AD 113, unaware of the network initiated handover, transmits an attachment ack (attachment acknowledge) to the MN 100 to notification of its readiness (step S2013). Upon receipt of the notification, the MN 100 starts to release the old connection using interface 1. Since the current interface 1 is already handed over to the AD 112, the release request is transmitted to the AD 112 (step S2014) and the AD 112 transmits a PBU to the SG 104 to eliminate the binding in the LMA (step S2015).

If the above PBU is processed by the SG 104, all binding entries related to the MN 100 in the SG 104 are deleted (step S2016). This causes a service interruption in the MN 100.

To prevent accidental changes in the binding entries, PMIPv6 (refer to Non-Patent Document 1) proposes use of an ATT (access technology type) value or use of an interface ID as a parameter in the PBU to help in deciding the correct action. However, the following cases cannot be resolved by this approach. The ADs 111, 112 and 113 all use the same access technology, that is, have different ATT values. Even if the AD 111 and the AD 112 have different technologies, the MN 100 can access them by using a single physical interface such as the UMTS (universal mobile telecommunications system) and LTE (long term evolution). The MN 100 uses different physical interfaces to access the AD 111 and the AD 112. The MN 100 cannot provide requested information such as an interface ID and handover information to the access network. Accordingly, the problem mentioned in reference to FIG. 2 also occurs with the means of Non-Patent Document 1.

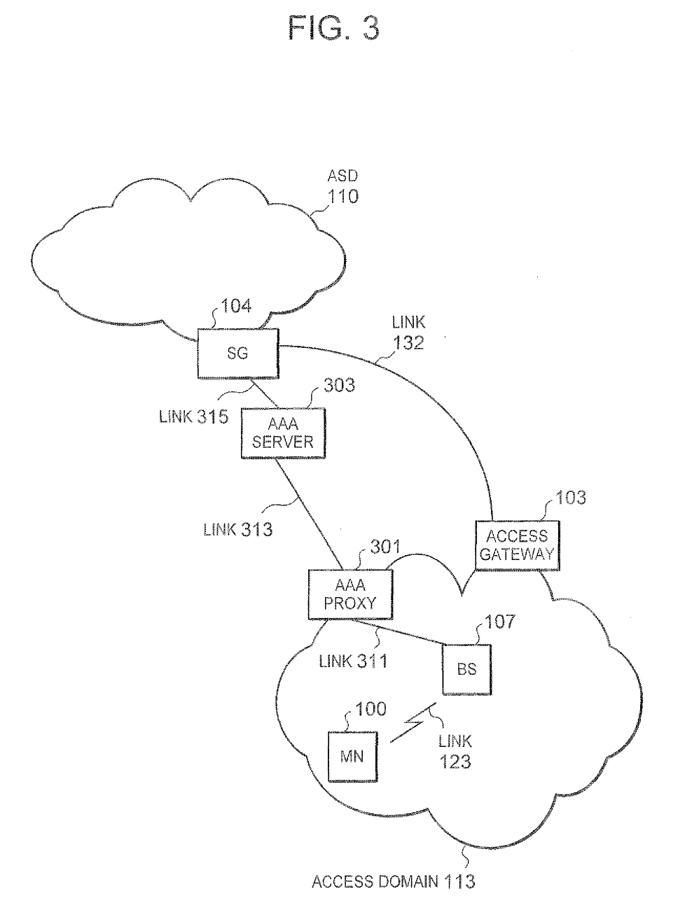

FIG. 3 shows an example of a network configuration supporting the present invention. FIG. 3 focuses on a part of the network shown in FIG. 1, and includes an extended AD 113 and ASD 110 to describe additional entities and connections. It is obvious to those skilled in the art that the network environment shown in FIG. 1 is taken into account.

As shown in FIG. 3, an AAA proxy 301 exists in the AD 113. The BS 107 connects to the AAA proxy 301 through a link 311. An AAA server 303 exists inside the network, such as in a home domain of the MN 100. The AAA proxy 301 connects to the AAA server 303 through a link 313. The AAA proxy 301 and AAA server 303 define a mechanism which authenticates and allows the MN 100 to connect to the AD 113. Moreover, the AAA server 303 can access the SG 104 through a link 315. Examples of the protocol implemented on the links 311, 313 and 315 are the RADIUS (remote authentication dial-in user service) and Diameter. The MN 100 directly communicates with the AAA server 303 by use of a mechanism such as the EAP (extensible authentication protocol) transported via different protocols implemented on these links.

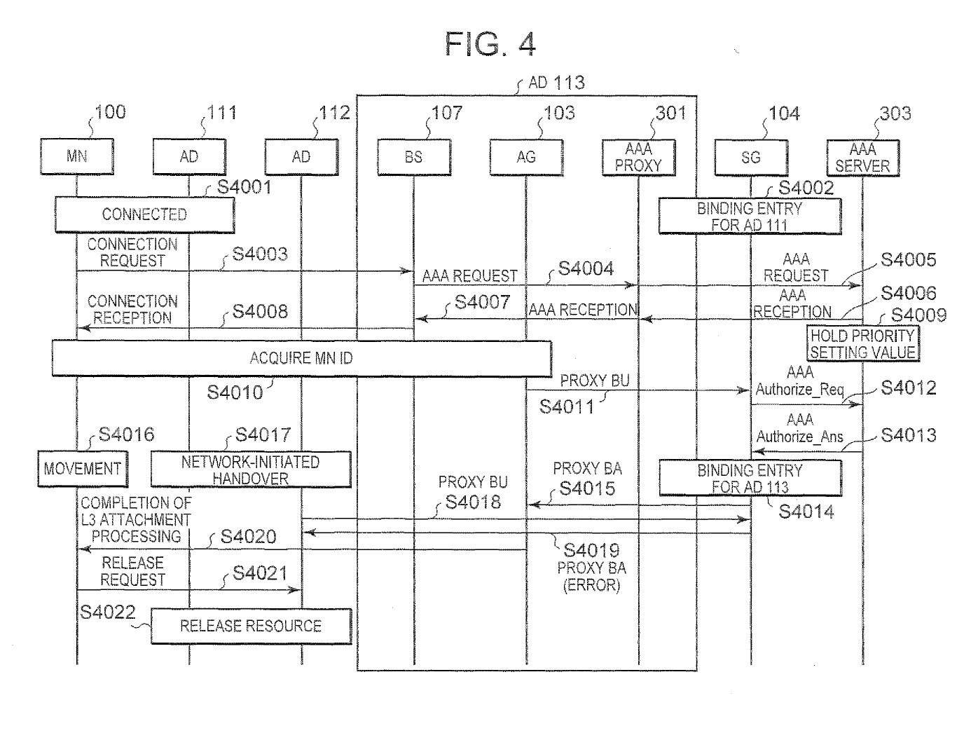

FIG. 4 shows an example of a processing sequence of the present invention in the network shown in FIG. 1 and FIG. 3. As shown in FIG. 4, in the beginning, the MN 100 receives the service via the AD 111, and the binding entry in the SG 104 is for the AD 111 in steps S4001 and S4002 as in FIG. 2.

The MN 100 finds the AD 113 and determines to connect to the AD 113. Thus, the MN 100 transmits a connection request to the BS 107 (step S4003). It is obvious to those skilled in the art that the connection request includes multiple substeps such as affiliation in the link layer and link layer verification. An example of the connection request is an EAPOL (extensible authentication protocol over LAN) message from the MN 100 to an access point, in which case the AD 113 uses a radio access technique such as IEEE802.11, for example. The MN 100 includes a PSV (priority setting value) of this connection in the connection request. A PSV indicates that the connection has a higher priority than other connections. This is an additional object (item) in an EAP (extensible authentication protocol) message, for example.

Note that it is a preferable embodiment of the present invention that in the handover processing method of the present invention, the above-mentioned information is information indicating that a priority for connecting to a desired access network is higher than a priority for connecting to other access networks. With this configuration, it is possible to reject path switching requests from access networks other than the desired access network. Note that the certain information being information indicating that a priority for connecting to a desired access network is higher than a priority for connecting to other access networks may be evaluated as a state where a PSV included in the certain information exceeds a certain value.

A connection request is a trigger for causing the BS 107 to perform an AAA procedure for the home domain of the MN 100. As shown in FIG. 4, the connection request includes an AAA request (steps S4004 and 34005) transmitted to the AAA server 303 via the AAA proxy 301. An example of the message is an EAP message transmitted from the MN 100 forwarded to the AAA server 303 in the Diameter message. A PSV indicated by the MN 100 is included in the message and is conveyed to the AAA server 303.

Note that it is a preferable embodiment of the present invention that in the base station of the present invention, if the aforementioned certain information is information indicating that a priority for connecting to a desired access network is higher than a priority for connecting to other access networks, message generation unit generates an authentication request message which includes the certain information and which causes an authentication device for authenticating a new connection to perform authentication, and transmission unit transmits the generated authentication request message to the authentication device. With this configuration, security can be assured by protection through the AAA procedure.

Upon receipt of the AAA request (step S4005), the AAA server 303 performs appropriate authentication and allowance processing. If the processing succeeds, the AAA server 303 transmits an AAA reception message to the BS 107 (AAA reception) (steps S4006, S4007). The BS 107 notifies the MN 100 of the result by the connection message (connection reception) (step S4008). It is obvious to those skilled in the art that a larger number of messages are exchanged depending on the AAA mechanism in the network, such as the EAP method.

At this time, the AAA server 303 holds the stored PSV together with an MN 100 entry (step S4009).

After the connection to the BS 107 succeeds, an ID of the MN 100 is presented to the AG 103, and the AG 103 acts as an MAG entity in the AD 113 (step S4010). It is obvious to those skilled in the art that details of such processing depend on the environment. For example, in a non-3GPP access network, the AG 103 serves as an ePDG, and an ID of the MN is presented during tunnel setup processing such as IKEv2 processing. Otherwise, the AG 103 may directly acquire the ID of the MN through the BS 107 by use of information from previous AAA processing.

The AG 103 transmits a PBU message (proxy BU) to the SG 104 (step S4011), and the SG 104 acts as an LMA entity in PMIPv6. The PBU message prompts the LMA to consult the AAA server 303 by use of AAA_Authorize_Req (step S4012) for allowance of connection of the MN 100. An example of this message is a Diameter PMIPv6 application message. Then the AAA server 303 responds with AAA_Authorize_Ans (step S4013) and forwards the PSV associated with the MN 100 to the SG 104.

Upon receipt of the AAA_Authorize_Ans message, the SG 104 associates the PSV and changes the binding entry for the AD 113 (step S4014). The SG 104 notifies the change in the binding entry through a PBA message (proxy BA) (step S4015).

Almost simultaneously, the MN 100 moves to a new position 100a (step S4016) which triggers network-initiated handover processing between the AD 111 and the AD 112 (step S4017). Then, the MAG entity in the AD 112 transmits a PBU message to the SG 104 (step S4018). However, the SG 104 rejects this request according to the registered PSV, and transmits a notification which is a PBA (error) including the reason of rejection (step S4019).

At the same time, the AG 103 completes the L3 attachment processing of the MN 100 (step S4020). In this processing, an RA or DHCP (dynamic host configuration protocol) message is transmitted to the MN 100 to configure a necessary Layer 3 parameter. If the processing succeeds, the MN 100 transmits a release request message to the AD 112 (or the AD 111) through the interface 1 (step S4021), and unused resource is released (step S4022).

According to the above processing sequence, it is clear that the MN 100 can perform a smooth handover and the service is not interrupted. An advantage of the method is that the system configuration is hardly affected. Hence, the same system messages can be used and security is assured by protection through the AAA procedure.

Note that it is a preferable embodiment of the present invention that in the handover processing method of the present invention, if the above-mentioned certain information is information indicating that a priority for connecting to a desired access network is higher than a priority for connecting to other access networks, a base station which receives messages and which is located in the desired network transmits an authentication request message including the certain information to an authentication device for authenticating a new connection, and after the authentication device authenticates the new connection in response to the authentication request message, the base station notifies a connection managing apparatus of the certain information so that path switching requests from base stations of access networks other than the desired access network are rejected. With this configuration, security can be assured by protection through the AAA procedure.

Moreover, an example of another processing sequence of the present invention can be described with reference to FIG. 4. In this processing sequence, the MN 100 does not include a PSV in the connection request in step S4003. Hence, the AAA server 303 does not have a PSV associated with an MN 100 entry. That is, there is no step S4009. Instead, when the MN 100 presents the ID of the MN 100 to the AG 103 in step S4010, the MN 100 indicates the PSV in the ID format. For example, if the ID of the MN 100 is indicated in the NAI (network access identifier) format described in Non-Patent Document 5 (such as User@Home.Domain), a PSV (priority setting value) is indicated as “PSV@User@Home.Domain).

Detecting the MN ID of such a format, the AG 103 extracts the PSV from the ID of the MN 100 and includes the PSV as an object of a different field in the PBU transmitted to the SG 104 (step S4011). Upon receipt of the PBU including the PSV, the SG 104 requests allowance of the connection to the AAA server 303 (steps S4012 and S4013). If the connection is allowed, the SG 104 associates the PSV and updates the binding entry (step S4014).

The remaining steps S4015 to S4022 of the processing sequence are the same as the aforementioned sequence, and thus descriptions are omitted. An advantage of the method is that no node other than the access gateway in the access network is affected.

Note that it is a preferable embodiment of the present invention that in the handover processing method of the present invention, if the above-mentioned certain information is information indicating that a priority for connecting to a desired access network is higher than a priority for connecting to other access networks, a generated message is a message for notifying a base station located in the desired access network of identification information on a mobile node. With this configuration, the certain information can be transmitted together with the identification information on the mobile node.

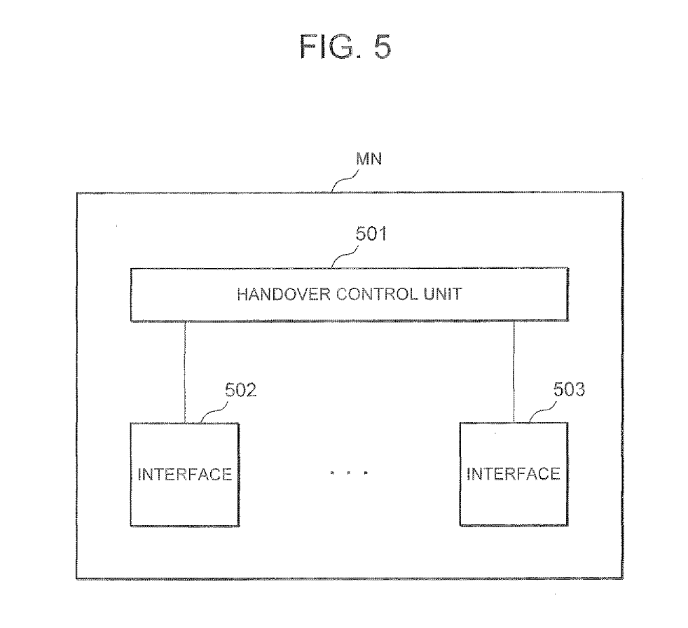

Next, the mobile node MN according to the first embodiment will be described with reference to FIG. 5. FIG. 5 is a configuration diagram showing an exemplar configuration of the MN supporting the present invention. As shown in FIG. 5, the MN comprises a handover control unit 501, a communication interface 502, and a communication interface 503. The handover control unit 501 controls and monitors the communication interfaces 502 and 503 through these communication interfaces.

In addition, the handover control unit 501 determines an interface when a node-initiated handover occurs. At the same time, when an internal interface handover or a handover between different access networks is performed, the handover control unit 501 generates an object of the PSV and generates an appropriate message or the like. The handover control unit 501 determines the PSV according to information collected from all interfaces, information from the user, input information on other protocol layers, and information from the MN itself such as information on the power supply state.

For example, an interface or an access network of a better communication state is set to have a higher priority. Otherwise, an interface or an access network which enables a higher communication rate is set to have a higher priority. Otherwise, an interface or an access network which provides a higher QoS is set to have a higher priority. Otherwise, an interface or an access network designated by the user is set to have a higher priority. Otherwise, an interface or an access network which supports a certain protocol is set to have a higher priority (such as an access network according to IEEE802.11). Otherwise, an interface or an access network which consumes less battery is set to have a higher priority. Note, in this case, that if there is a large amount of remaining battery capacity, a higher priority may be set even if the interface or the access network consumes a large amount of battery. Note that the MN described herein is the same in the later-described second and third embodiments.

Note that it is a preferable embodiment of the present invention that in a mobile node of the present invention, the above-mentioned certain information is information indicating that a priority for connecting to a desired access network is higher than a priority for connecting to other access networks, or information indicating that the priority for connecting to the access networks other than the desired access network is lower than the priority for connecting to the desired network. With this configuration, path switching requests from access networks other than the desired access network can be rejected.

It is also a preferable embodiment of the present invention that in the mobile node of the present invention, if the above-mentioned certain information is information indicating that a priority for connecting to a desired access network is higher than a priority for connecting to other access networks, a message generated by message generation unit is a message for notifying a base station located in the desired access network of identification information of the mobile node. With this configuration, the certain information can be transmitted together with the identification information on the mobile node.

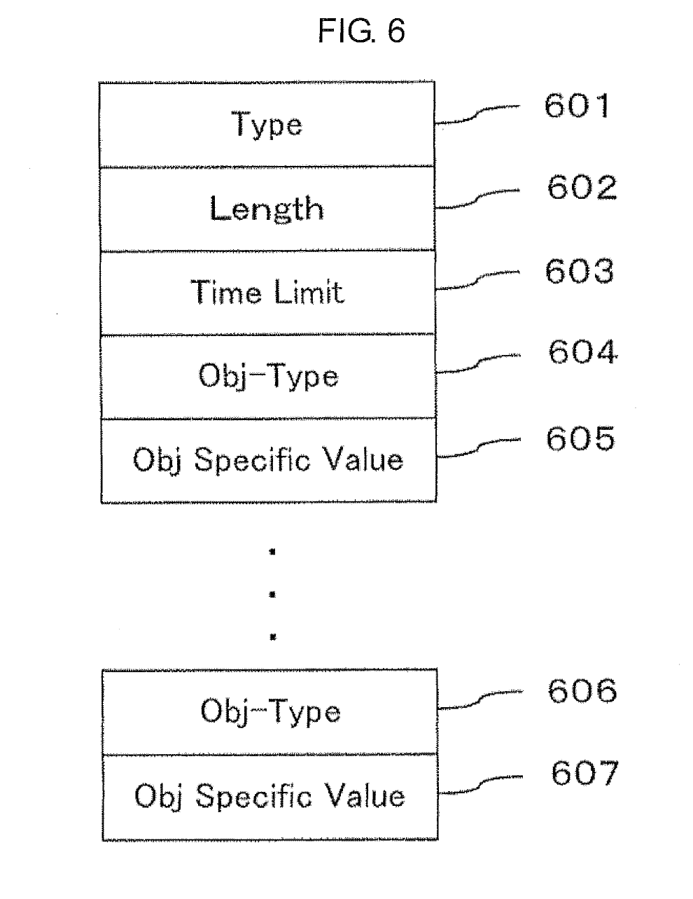

FIG. 6 is an example message format showing an example of an object of a PSV. As described above, the PSV can be conveyed in different message types. For this reason, the PSV is defined in the form of TLV (Type-Length-Value), is applicable to most protocol messages, can be easily included, and can be easily described.

A PSV object starts from a Type field 601. This value varies depending on the numbering space of a protocol for conveying the PSV object. For example, different type values are defined to identify the PSV object for the EAP and Diameter.

A Length field 602 indicates an entire length of the PSV object in byte units. This field is two bytes in length, for example.

A Time Limit field 603 indicates how long the PSV is valid. For example, the field is one byte in length, and its value indicates the duration for which the PSV is valid. A value 255 indicates that the PSV is permanently valid. A value zero indicates that the PSV is to be removed. That is, the value is set to the default value.

An Obj-Type field 604 and an Obj Specific Value field 605 are shown in a pair. One or more pairs such as an Obj-Type field 606 and an Obj Specific Value field 607 in addition to the Obj-Type field 604 and the Obj Specific Value field 605 exist in a single PSV object.

The Obj-Type field 604 is one byte in length, and takes the following value. 0×01:=PSV value meaning positive, 0×02:=PSV value meaning negative, 0×03:=current access type having higher priority than access type described in Obj-Specific Value field, 0×04:=current access type having lower priority than access type described in Obj-Specific Value field, 0×05:=current interface having higher priority than interface described in Obj-Specific Value field, 0×06:=current interface having lower priority than interface described in Obj-Specific Value field.

The Obj Specific Value field 605 includes values according to the Obj-Type field 604. For example, a PSV, an access type, an interface ID and the like.

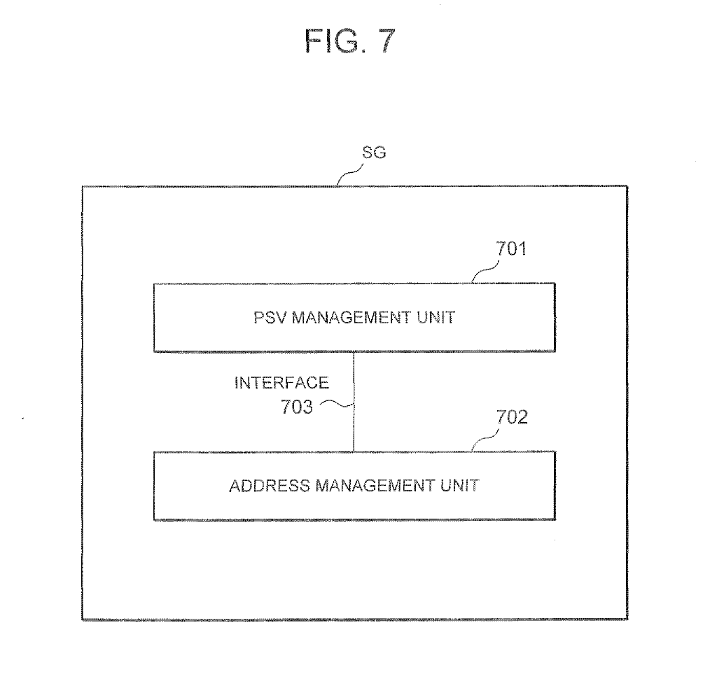

Next, the connection managing apparatus SG according to the first embodiment will be described with reference to FIG. 7. FIG. 7 is a configuration diagram showing an example of the SG of the present invention. As shown in FIG. 7, the SG comprises a PSV management unit 701 and an address management unit 702. The two means are linked with an interface 703.

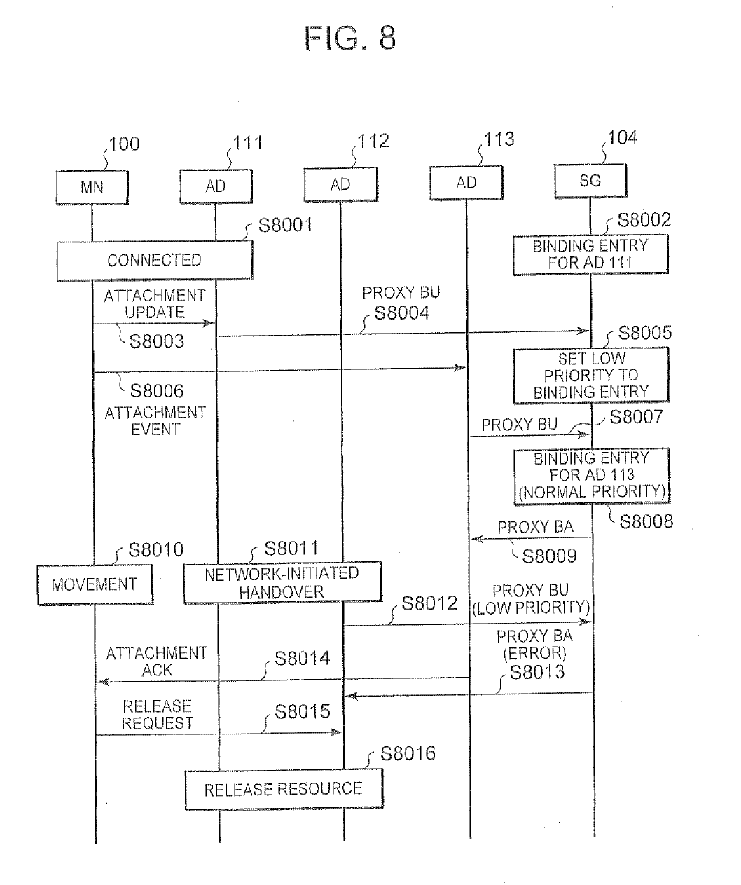

The PSV management unit 701 manages PSVs for the respective MN address entries. This means that each binding cache entry in PMIP in the SG is associated with a PSV. The PSV management unit 701 acquires a value for each entry as described above. For example, the PSV management unit 701 acquires the value in step S4013 (step S4011 if NAI is applied) in FIG. 4, or in step S8004 of FIG. 8 in the later-mentioned second embodiment. Note that a unit for managing the PSVs may be a group of multiple addresses. For example, PDN connection indicated in Non-Patent Documents 2 and 3 may be used as a unit, and if a single PDN connection has multiple address types, the multiple addresses can be unified into a single entry, so that managing load can be reduced.

The address management unit 702 manages address binding cache entries in the MN. The address management unit 702 handles the address binding cache on the basis of the associated PSV. For example, the address management unit 702 replaces an entry only if an address indicated in a new PBU has a larger PSV than a stored address. PSVs of the address in the PBU and of the stored address are managed by the PSV management unit 701 via the interface 703. Note that the SG described herein is the same in the later-described second and third embodiments.

Note that it is a preferable embodiment of the present invention that in the connection managing apparatus of the present invention, the above-mentioned certain information is information indicating that a priority for connecting to a desired access network is higher than a priority for connecting to other access networks, or information indicating that the priority for connecting to the access networks other than the desired access network is lower than the priority for connecting to the desired network. With this configuration, path switching requests from access networks other than the desired access network can be rejected.

It is also a preferable embodiment of the present invention that in the connection managing apparatus of the present invention, if the above-mentioned certain information is information indicating that a priority for connecting to a desired access network is higher than a priority for connecting to other access networks, after an authentication device for authenticating a new connection receives an authentication request message including the certain information transmitted by a base station which receives messages and which is located in the desired network, and then authenticates the new connection in response to the authentication request message, reception unit receives from the authentication device the certain information for rejecting path switching requests from base stations of access networks other than the desired access network. With this configuration, security can be assured by protection through the AAA procedure.

It is also a preferable embodiment of the present invention that in the connection managing apparatus of the present invention, if the above-mentioned certain information is information indicating that a priority for connecting to the access networks other than the desired access network is lower than the priority for connecting to the desired network, determination unit performs path switching processing to switch to an access network other than the desired access network by associating the certain information acquired from a base station located in an access network to which the mobile node is currently connected, and thereafter performs path switching processing in response to a path switching request message from a base station located in the desired access network; and in a case where reception unit receives a path switching request message including the certain information from a base station located in an access network other than the desired access network, the determination unit rejects, on the basis of the certain information, the path switching request from the base station located in the access network other than the desired access network. This configuration ensures path switching to the desired access network.

### Second Embodiment

FIG. 8 shows an example of another processing sequence of the present invention. Note that since the network configuration of the second embodiment is the same as the network configuration in the first embodiment, descriptions are given with reference to FIG. 1. As shown in FIG. 8, an MN 100 receives a service from an SG 104 via an AD 111, and the SG 104 has a binding entry for the AD 111 (steps S8001 and S8002).

The MN 100 finds an AD 113, determines to perform a handover and transmits an attachment update message (attachment update) indicating that the link has a low priority to the AD 111 before handover (step S8003). Upon receipt of the attachment update message indicating the low priority, a MAG entity of the AD 111 transmits a PBU including a low PSV to the SG 104 (step S8004). For example, the PBU includes an additional PSV object.

Note that it is a preferable embodiment of the present invention that in the handover processing method of the present invention, the above-mentioned certain information is information indicating that a priority for connecting to access networks other than the desired access network is lower than the priority for connecting to the desired network. With this configuration, it is possible to reject path switching requests from access networks other than the desired access network.

Upon receipt of the PBU, the SG 104 updates the binding entry and associates (sets) a low priority with this entry (step S8005).

At the same time, the MN 100 starts to set up a connection with the AD 113 by an attachment event (step S8006). It is obvious to those skilled in the art that the attachment event includes multiple substeps such as verification of the link layer. The AD 113 is prompted by the attachment event and transmits a PBU for updating the binding entry to the SG 104 (step S8007). This PBU does not include any special PSV, and in this case is considered to include a normal priority. Hence, the SG 104 updates the binding entry for the AD 113 and associates a normal priority with this entry (step S8008). The SG 104 notifies the AD 113 of the result with a proxy BA (PBA) (step S8009).

At the same time, the MN 100 moves to a new position 100a (step S8010) which causes the network to prompt the AD 111 and the AD 112 to perform network-initiated handover processing (step S8011). During the network-initiated handover processing, the AD 111 notifies the AD 112 of the associated low priority through context transfer (step S8011).

The AD 112 transmits a proxy BU (PBU) indicating the low priority to the SG 104 (step S8012). The PBU including the low PSV fails to update the binding entry in the SG 104 associated with the normal priority. Accordingly, the SG 104 transmits a PBA (error) to notify the AD 112 of the error (step S8013).

At the same time, the AD 113 notifies the MN 100 of success of the connection by transmitting an attachment ack (step S8014). It is obvious to those skilled in the art that an attachment ack may take the form of an RA or a DHCP message other than a dedicate message.

The MN 100 transmits a release request to the AD 112 via an interface 1 (step S8015). This allows the AD 111 and the AD 112 to release unnecessary resource (step S8016).

The above-mentioned processing also allows the MN 100 to perform a smooth handover without interruption in the service. An advantage of the method is that no change is made in signaling of a node-initiated handover. The MN only needs to carry out a normal procedure for a new connection, and processing is not affected. The MN may determine to set a PSV after detecting a new connection to a radio link, for example. This can suppress unnecessary signaling. Moreover, if the user determines to increase a PSV to a normal value or higher, for example, the MN is capable of changing the priority any time.

Note that in a case where it is known in advance that the MN is highly likely to perform a handover to a different interface or access network, such as a case where the MN includes a high-capacity communication interface but is using another interface (referred to here as interface A) at that point, a low PSV may be reported by use of an attachment message as in the aforementioned case when connecting (attaching) via the interface A. This eliminates the need to transmit an attachment update message at the time of a handover, which reduces handover processing and thus shorten the time required for a handover.

Note that it is a preferable embodiment of the present invention that in the handover processing method of the present invention, if the above-mentioned certain information is information indicating that a priority for connecting to access networks other than the desired access network is lower than the priority for connecting to the desired network, a connection managing apparatus: performs path switching processing to switch to an access network other than the desired access network by associating the certain information acquired from a base station located in an access network to which the mobile node is currently connected; performs path switching processing in response to a path switching request message from a base station located in the desired access network; and in a case of receiving a path switching request message including the certain information from a base station located in an access network other than the desired access network, rejects, on the basis of the certain information, the path switching request from the base station located in the access network other than the desired access network. This configuration ensures path switching to the is desired access network.

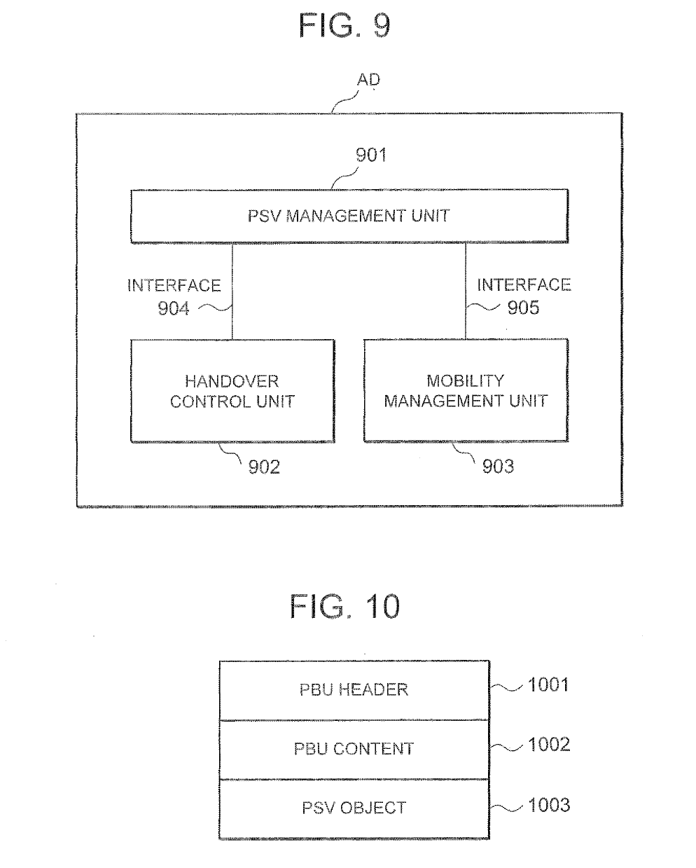

Next, the AD according to the second embodiment will be described with reference to FIG. 9. FIG. 9 is a configuration diagram showing an exemplar configuration of the AD 111 and the AD 112. This supports the processing as shown in FIG. 8. Hereinafter, descriptions will be given by referring to the AD 111 and the AD 112 as the AD.

As shown in FIG. 9, the AD includes three components which are a PSV management unit 901, a handover control unit 902 and a mobility management unit 903.

The PSV management unit 901 holds PSVs of MNs associated with the AD. The PSVs are acquired through signaling between the MN and the AD as in step S8003 of FIG. 8, for example.

The mobility management unit 903 performs mobility management of the MNs such as transmitting PBUs to the SG. The mobility management unit 903 inserts a PSV associated with the MN, which is acquired from the PSV management unit 901 via the interface 905, into a PBU.

The handover control unit 902 performs control of network-initiated handovers of MNs. For example, the handover control unit 902 selects a new AD such as the AD 112, or transfers an access context to the AD 112. The handover control unit 902 of the currently-connected AD such as the AD 111 includes a PSV associated with the MN when transferring a context. The PSV is acquired from the PSV management unit 901 via the interface 904.

When the handover control unit 902 of the AD 112 receives a context, the handover control unit 902 collects the PSV and forwards it to the PSV management unit 901 via the interface 904.

Here, an example of a message format of the PBU in step S8007 (step S4011 in the first embodiment if NAI is applied) is shown in FIG. 10.

As shown in FIG. 10, a PBU header 1001 and a PBU content 1002 conform to those defined in Non-Patent Document 1. A PSV object 1003 is the same as that shown in FIG. 6. It is also obvious to those skilled in the art that a PSV object can be integrated into the PBU content 1002 as needed.

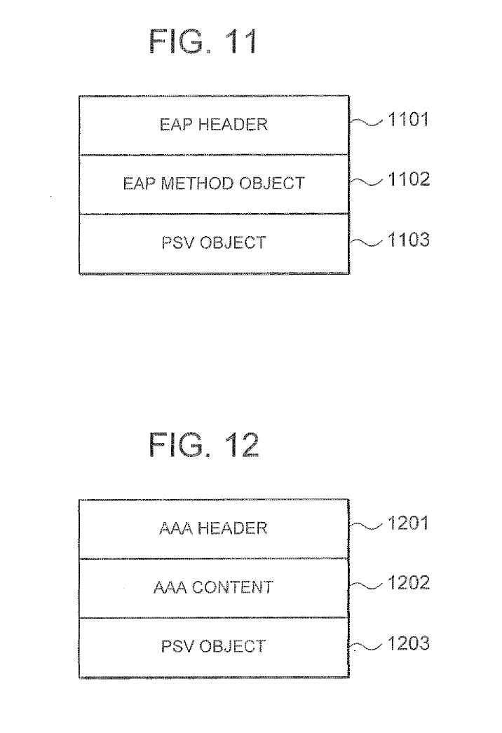

FIG. 11 shows an example of a message format of an extended EAP message used in steps S4003, S4004 and S4005 of the first embodiment. As shown in FIG. 11, an EAP header 1101 is the same as that defined in Non-Patent Document 4. An EAP method object 1102 is a method specific object conveyed by an EAP message such as an EAP-AKA message. A PSV object 1103 is the same as that shown in FIG. 6.

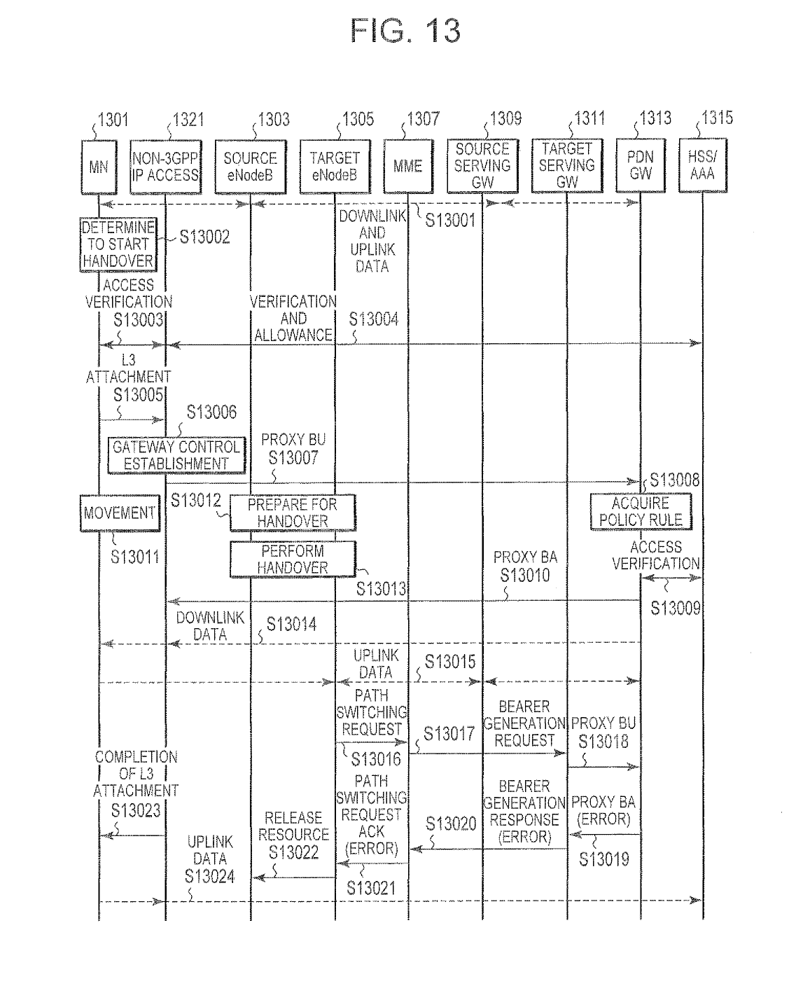

FIG. 12 shows an example of a message format of an extended AAA_Authorize_Ans message conveyed from AAA server 303 to SG in step S4013 of the first embodiment. As shown in FIG. 12, an AAA header 1201 and an AAA content 1202, as defined in Non-Patent Document 4, are the same as those of a protocol required in an interaction between the AAA server and the LMA. The PSV object 1203 is the same as that shown in FIG. 6. It is obvious to those skilled in the art that the PSV object 1203 becomes a part of a TLV (Type Length Value) object of an AAA protocol.

### Third Embodiment

In the first and second embodiments described above, the AD 111, the AD 112 and the AD 113 are shown as normal networks. Accordingly, in a case of a special environment, the present invention needs to be adapted to the environment. FIG. 13 shows an example processing sequence in an actual network. In this example, an AD 111 and an AD 112 are different sub domains in a 3G network, and the 3G network includes different eNodeBs (1303 and 1305) and different SGs (1309 and 1311). An AD 113 is a non-3GPP IP access 1321 which interacts with the 3G network. The service is provided to an MN 1301 via a PDN GW 1313 corresponding to the SG in the above embodiments. Examples of a detailed configuration are shown in Non-Patent Documents 2 and 3.

As shown in FIG. 13, the MN 1301 starts to receive a service from the PDN GW 1313 through the source eNodeB 1303 and the source SG 1309 (step S13001).

At one point, the MN 1301 finds the non-3GPP IP access 1321 and determines to start a handover (step S13002). The MN 1301 starts the processing by performing access authentication (step S13003), and these message exchanges are transferred to an HSS/AAA 1315 which is in a home domain of the MN 1301 via the non-3GPP IP access 1321 (step S13004). During the exchanging of authentication messages, the MN 1301 presents a PSV to the network. This is included in an additional object in EAP messages exchanged with the HSS/AAA 1315, for example. Thereafter, the HSS/AAA 1315 holds the PSV in association with an ID of the MN.

In a case where a PDN connection targeted for a handover to the non-3GPP IP access 1321 is specified (a PDN connection ID, PDN connection identification information such as an IP address or prefix information are included in access authentication (otherwise referred to as attach processing), for example), the HSS/AAA 1315 holds the PSV in association with the MN ID and PDN connection identification information. Thus, only a certain PDN connection is targeted for a handover, and the other PDN connections can be left in the handover source access network. In other words, originally, the connections of the handover source access networks AD 111 or the AD 112 should all be disconnected along with the handover to the AD 113. However, by specifying the PDN connection targeted for a handover and managing the PSV in association with the MN ID and the specified PDN connection identification information, in a case where PDN connections not targeted for a handover are left in the handover source access network, the PDN connections can be prevented from being disconnected from the handover source access network. With this configuration, PDN connections which should be left in the handover source access network can be prevented from being disconnected while in use, so that handover processing can be performed without degrading the user-convenience.

The MN 1301 continues to perform L3 (Layer 3) attachment (step S13005). In this case, for example, if the non-3GPP IP access 1321 is a trusted network, the attachment is an RS message, and if the non-3GPP IP access 1321 is an untrusted network, the attachment is an IPSec tunnel establishment message exchanged with an ePDG, such as IKEv2. Note that an untrusted network is the Untrusted Non-3GPP IP Access described in Non-Patent Document 3, for example.

Upon receipt of the Layer 3 attachment, the non-3GPP IP access 1321 performs gateway control establishment processing according to need (step S13006). For example, the non-3GPP IP access 1321 contacts the PCRF (policy and charging rules function) related to session establishment. A MAG entity of the non-3GPP IP access 1321 such as an ePDG transmits a proxy BU (PBU) to the PDN GW 1313 for updating of the binding entry (step S13007).

By receiving the PBU, the PDN GW 1313 acquires a related policy rule (step S13008), that is, contacts the PCRF related to policies and accounting rules, for example. In addition, the PDN GW 1313 contacts the HSS/AAA 1315 for allowance of updating the binding entry (step S13009). At the time of allowing the update, the HSS/AAA 1315 notifies the PDN GW 1313 of the PSV previously presented by the MN 1301. Accordingly, the PDN GW 1313 associates the PSV and updates the binding entry to obtain a binding entry for the non-3GPP IP access 1321. The PDN GW 1313 notifies the non-3GPP access 1321 of the update in the binding entry by transmitting a proxy BA (PBA) (step S13010).

Note that the PDN GW 1313 can revise the PSV according to information acquired from the PCRF. For example, if it is not desirable in the PF from the viewpoint of QoS or charging to establish the PDN connection in the handover target access network (such as cases of network congestion, determining that a certain QoS cannot be assured because of a static or dynamic property of the network, or determining that the charge is expensive), the PCRF instructs the PDN GW 1313 to lower the PSV. Here, the PCRF may present a specific revised value or present a new PSV. Moreover, the PDN GW 1313 may report the revised PSV to the HSS/AAA 1315 to update the value, or the PCRF may report the revised PSV to the HS/AAA 1315 to update the value.

Alternatively, the AAA server may perform such revision of the PSV, in which case it is determined whether or not to make the revision according to a roaming agreement or the like, for example.

Almost simultaneously, the MN 1301 moves to a new position 100a (step S13011). In response, the source eNodeB 1303 attempts a handover to the target eNodeB 1305 (step S13012). The handover is performed by transmitting downlink data to the target eNodeB 1305 (step S13013). Otherwise, the source eNodeB 1303 may transmit a handover required message to an MME 1307 and the MME 1307 may mediate between the source and target eNodeBs.

The downlink data to the MN 1301 is transmitted from the PDN GW 1313 to the MN 1301 through the non-3GPP IP access 1321 (step S13014). This is because the PDN GW 1313 has the already-updated binding entry. Uplink data from the MN 1301 is transmitted to the PDN GW 1313 via the target eNodeB 1305 and the source SG 1309 (step S13015). This is because the MN 1301 has not received a confirmation from the non-3GPP IP access 1321, and thus still uses the 3G interface.

The target eNodeB 1305 transmits a path switching request to the MME 1307 (step S13016). The MME 1307 transmits a bearer generation request to the target SG 1311 (step S13017). The target SG 1311 transmits a proxy BU (PBU) to the PDN GW 1313 to update the binding entry (step S13018). The PBU is rejected since the binding entry in the PDN GW 1313 has a higher PSV.

Accordingly, the PDN GW 1313 transmits a PBA (error) including an error code of the reason of rejection to the target SG 1311 (step S13019). The target SG 1311 transmits a bearer generation response including the error code to the MME 1307 (step S13020). The MME 1307 notifies the target eNodeB 1305 of the error with a path switching request ack (step S13021). The target eNodeB 1305 determines to start releasing resource, and the source eNodeB 1303 is notified of the connection failure upon receipt of the resource release request from the target eNodeB 1305 (step S13022).

Almost simultaneously, the non-3GPP IP access 1321 (or the ePDG) transmits a Layer 3 attachment completion message to the MN 1301 (step S13023). This message may take the form of an RA or a DHCP message instead of a dedicate message. Upon receipt of the message, the MN 1301 switches the interface for data transmission, and uses the non-3GPP IP access 1321 to transmit data toward the PDN GW 1313 (step S13024).

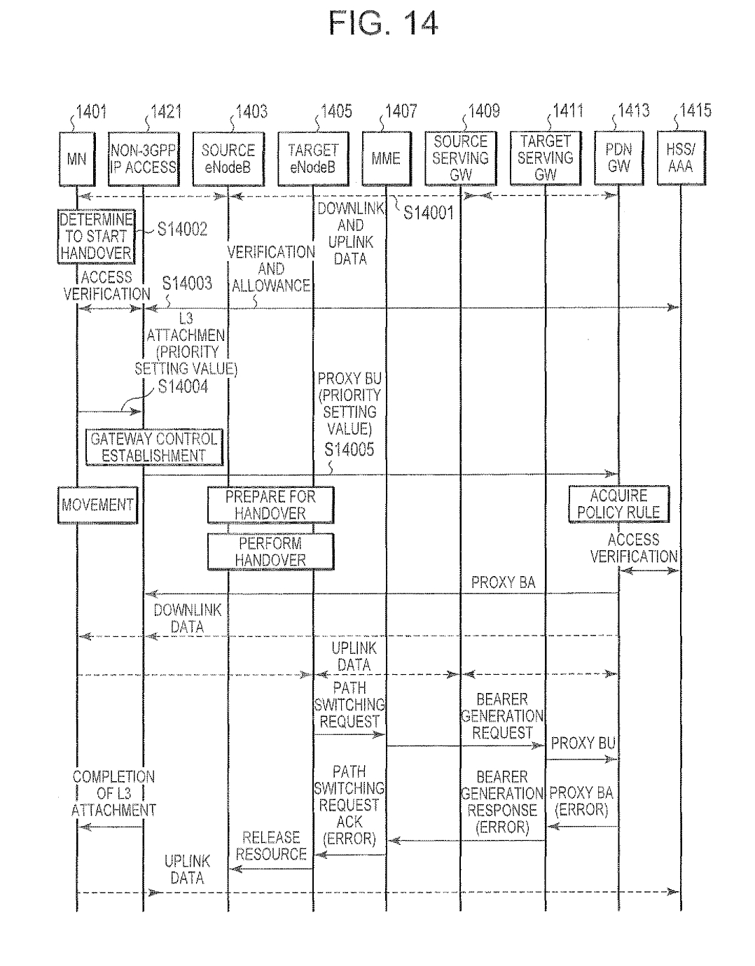

FIG. 14 shows an example of another processing sequence of the present invention. This processing sequence is almost the same message exchange sequence as that shown in FIG. 13. However, in step S14003, an MN 1401 does not include the PSV information. Instead, the MN 1401 includes a PSV in a Layer 3 attachment message (step S14004). For example, depending on whether a non-3GPP IP access 1421 is trusted or untrusted, the message may be an RS, IKE or IKEv2 message provided with a PSV object.

The non-3GPP IP access 1421 (ePDG) includes the PSV in a proxy BU (PBU) transmitted to a PDN GW 1413 (step S14005). With this, the PDN GW 1413 updates the binding entry and associates the PSV with the entry.

Rest of the processing sequence is the same as that shown in FIG. 13. It is apparent that the MN 1401 can perform a smooth handover by this processing sequence.

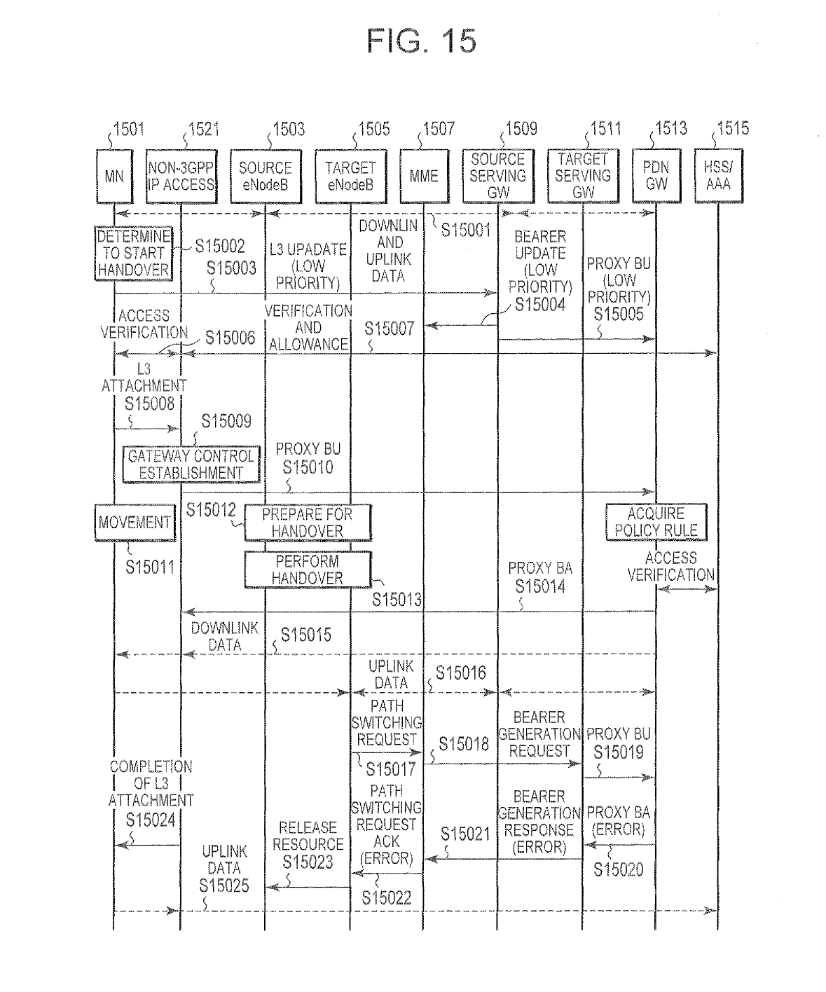

FIG. 15 shows another processing sequence of the present invention. Entities in the processing sequence are the same as those shown in FIG. 13 and FIG. 14. An MN 1501 starts a connection with a source eNodeB 1503 and a source SG 1509 (step S15001). After determining to perform a handover to a non-3GPP IP access 1521 (step S15002), the MN 1501 transmits an L3 (Layer 3) update message to the source SG 1509 through a 3G interface (step S15003). The MN 1501 indicates in the Layer 3 message that the MN 1501 desires to lower the priority of the 3G connection.

Upon receipt of the L3 update message, the source SG 1509 transmits a bearer update message to an MME 1507 (step S15004). The message indicates that a low PSV is set. The bearer update message takes the form of a bearer generation response message.

At the same time, the source SG 1509 transmits a PBU to a PDN GW 1513 to lower the priority of the binding entry for itself (step S15005).

The MN 1501 starts access authentication, and starts to set up a connection with the non-3GPP IP access 1521 (step S15006). Step S15006 to step S15009 are a part of connection setup processing and are the same as the step S13003 to step S13006 in FIG. 13.

A PBU transmitted by a MAG entity (or an ePDG) of the non-3GPP IP access 1521 (step S15010) does not include a special PSV. Hence, the PDN GW 1513 handles the PBU as having a default priority. Accordingly, the PDN GW 1513 changes the current binding entry to that for the non-3GPP IP access 1521, and associates a normal priority to the entry.

The MN 1501 moves to a new position (step S15011), and the source eNodeB 1503 starts a handover to a target eNodeB 1505 (step S15012). Step S15012 to Step S15017 are a part of a network-initiated handover and are the same as the step S13012 to step S13016 of FIG. 13.

Upon receipt of a path switching request from the target eNodeB 1505 (step S15017), the MME 1507 transmits a bearer generation request including a PSV of a low priority to a target SG 1511 (step S15018). The target SG 1511 transmits a PBU including the same PSV to the PDN GW 1513 (step S15019).

The PDN GW 1513 rejects the received PBU according to the PSV. Specifically, the stored binding entry has a normal PSV associated thereto, whereas the received PBU has a low PSV. For this reason, the PDN GW 1513 responds with a PBA indicating an error (step S15020). Rest of the processing such as processing of step S15021 to step S15025 is the same as the processing of the step S13020 to step S13024 in FIG. 13.

Note that the invention shown in the above embodiments is applicable to various types of network combinations as long as a predetermined state is satisfied, that is, the AD 111 and the AD 112 support a network-initiated handover, and the AD 113 supports a node-initiated handover. It is particularly advantageous to employ the following settings.

The AD 111 and the AD 112 are UMTS networks and the AD 113 is an LTE network. The AD 111 and the AD 112 are UMTS networks and the AD 113 is an IMT-advanced network. The AD 111 and the AD 112 are 3GPP networks and the AD 113 is a non-3GPP network such as WIMAX, WLAN (wireless local area network) or 3GPP2. The AD 111 and the AD 112 are non-3GPP networks and the AD 113 is a 3GPP network (such as any of the UMTS, LTE and IMT-advanced networks or a mixture of several types of networks).

In the above embodiments, PMIPv6 is used to describe an example. However, it is obvious to those skilled in the art that the solving means can also be applied to cases where other networks managing mobility schemes are employed (such as where GTP or the like is employed).

Note that each of the functional blocks used in the above embodiments of the present invention is generally realized as an LSI (large scale integration) which is an integrated circuit. The functional blocks may be individually implemented as chips, or may be implemented as a chip including a part or all of the functions. Note that although the integrated circuit is referred to here as an LSI, it may be referred to as IC (integrated circuit), system LSI, super LSI or ultra LSI, depending on the degree of integration.

Moreover, the method of creating an integrated circuit is not limited to the LSI, and may be realized by a private circuit or a general purpose processor. An FPGA (field programmable gate array) which is programmable after manufacturing of an LSI, or a reconfigurable processor in which connections in circuit cells inside an LSI and settings are reconfigurable can also be used.

Furthermore, if a technique for creating an integrated circuit appears in place of the LSI due to progress in the semiconductor technique or by another technique derived therefrom, the functional blocks may be integrated by use of the technique, as a matter of course. For example, application of biotechnology is conceivable.

### INDUSTRIAL APPLICABILITY

The handover processing method for a mobile node, the mobile node, the connection managing apparatus and the base station used in the method of the present invention enable a smooth handover without service interruption, and allow a desired handover to be performed. Accordingly, the invention relates to the handover processing method for a mobile node, the mobile node, the connection managing apparatus and the base station used in the method for a case where there are multiple entities that control a handover of the mobile node, and where the control entities perform the handovers of the mobile node around the same time.

1-16. (canceled)

17. A handover processing method for a mobile node applied to a case where, in a communication system in which a mobile node is configured to communicate with a correspondent node via a communication network formed of a plurality of access networks and which includes a connection managing apparatus managing connections of the mobile node, a plurality of entities for controlling handovers of the mobile node exist, including the mobile node itself, and some of the plurality of entities may perform handover processing of the mobile node, the method comprising the steps of:
generating by the mobile node a message including certain information for prioritizing a connection of the mobile node to a desired access network among the plurality of access networks;
transmitting the generated message from the mobile node to any of a base station located in the desired access network or a base station located in a currently-connected access network; and
rejecting by the connection managing apparatus a path switching request issued for a handover of the mobile node by a base station in an access network other than the desired access network, the rejection being made in accordance with the certain information acquired through the base station which receives the transmitted message.

18. The handover processing method according to claim 17, wherein the certain information is any of information indicating that a priority for connecting to the desired access network is higher than a priority for connecting to another access network, or information indicating that the priority for connecting to an access network other than the desired access network is lower than the priority for connecting to the desired access network.

19. The handover processing method according to claim 18, wherein
if the certain information is information indicating that the priority for connecting to the desired access network is higher than the priority for connecting to another access network,
the base station which receives the message and which is located in the desired access network transmits an authentication request message including the certain information to an authentication device for authenticating a new connection, and
the authentication device authenticates a new connection in response to the authentication request message, and then notifies the connection managing apparatus of the certain information so that the path switching request from a base station of an access network other than the desired access network is rejected.

20. The handover processing method according to claim 18, wherein
if the certain information is information indicating that the priority for connecting to the desired access network is higher than the priority for connecting to another access network,
the generated message is a message for notifying the base station located in the desired access network of identification information on the mobile node.

21. The handover processing method according to claim 18, wherein
if the certain information is information indicating that the priority for connecting to an access network other than the desired access network is lower than the priority for connecting to the desired access network,
the connection managing apparatus performs path switching processing to switch to an access network other than the desired access network while associating the certain information acquired from the base station located in the access network to which the mobile node is currently connected, then performs path switching processing in response to a path switching request message from the base station located in the desired access network, and thereafter, in a case of receiving a path switching request message including the certain information from a base station located in an access network other than the desired access network, rejects the path switching request from the base station located in the access network other than the desired access network according to the certain information.

22. A mobile node used in a handover processing method for a mobile node applied to a case where, in a communication system in which the mobile node is configured to communicate with a correspondent node via a communication network formed of a plurality of access networks and which includes a connection managing apparatus managing connections of the mobile node, a plurality of entities for controlling handovers of the mobile node exist, including the mobile node itself, and some of the plurality of entities may perform handover processing of the mobile node, the mobile node comprising:
message generation unit for generating a message including certain information for prioritizing a connection of the mobile node to a desired access network among the plurality of access networks; and
transmission unit for transmitting the generated message to any of a base station located in the desired access network or a base station located in a currently-connected access network.

23. The mobile node according to claim 22, wherein the certain information is any of information indicating that a priority for connecting to the desired access network is higher than a priority for connecting to another access network, or information indicating that the priority for connecting to the access network other than the desired access network is lower than the priority for connecting to the desired access network.

24. The mobile node according to claim 23, wherein
if the certain information is information indicating that the priority for connecting to the desired access network is higher than the priority for connecting to another access network,
the message generated by the message generation unit is a message for notifying the base station located in the desired access network of identification information on the mobile node.

25. A connection managing apparatus used in a handover processing method for a mobile node applied to a case where, in a communication system in which the mobile node is configured to communicate with a correspondent node via a communication network formed of a plurality of access networks and which includes a connection managing apparatus managing connections of the mobile node, a plurality of entities for controlling handovers of the mobile node exist, including the mobile node itself, and some of the plurality of entities may perform handover processing of the mobile node, the connection managing apparatus comprising:
reception unit for receiving a path switching request message from a base station located in an access network other than an access network that the mobile node desires among the plurality of access networks;
determination unit for determining whether or not to reject a path switching request issued for a handover of the mobile node which is a request from the base station located in the access network other than the desired access network, the determination being made in accordance with certain information included in a message generated by the mobile node and prioritizing a connection of the mobile node to the desired access network among the plurality of access networks; and
transmission unit for, in a case where the path switching request is determined to be rejected, transmitting a message indicating the rejection of the path switching request to the base station located in the access network other than the desired access network.

26. The connection managing apparatus according to claim 25, wherein the certain information is any of information indicating that a priority for connecting to the desired access network is higher than a priority for connecting to another access network, or information indicating that the priority for connecting to the access network other than the desired access network is lower than the priority for connecting to the desired access network.

27. The connection managing apparatus according to claim 26, wherein
if the certain information is information indicating that the priority for connecting to the desired access network is higher than the priority for connecting to another access network,
after an authentication device for authenticating a new connection receives an authentication request message including the certain information transmitted from the base station which receives the message and which is located in the desired access network, and authenticates a new connection in response to the authentication request message,
the reception unit receives from the authentication device the certain information for rejecting the path switching request from the base station located in the access network other than the desired access network.

28. The connection managing apparatus according to claim 26, wherein
if the certain information is information indicating that the priority for connecting to an access network other than the desired access network is lower than the priority for connecting to the desired access network,
the determination unit performs path switching processing to switch to an access network other than the desired access network while associating the certain information acquired from the base station located in the access network to which the mobile node is currently connected, then performs path switching processing in response to a path switching request message from the base station located in the desired access network, and thereafter, in a case where the reception unit receives a path switching request message including the certain information from a base station located in an access network other than the desired access network,
the determination unit rejects the path switching request from the base station located in the access network other than the desired access network according to the certain information.
